(19) United States
(12) Patent Application Publication
(10) Pub. No.: US 2017/0121839 A1
(43) Pub. Date: May 4, 2017

(54) METHOD FOR MANUFACTURING PISTON FOR INTERNAL COMBUSTION ENGINE

(71) Applicant: TOYOTA JIDOSHA KABUSHIKI KAISHA, Toyota-shi (JP)

(72) Inventors: Hideo YAMASHITA, Mishima-shi (JP); Akio KAWAGUCHI, Suntou-gun (JP); Hiroki IGUMA, Susono-shi (JP)

(73) Assignee: TOYOTA JIDOSHA KABUSHIKI KAISHA, Toyota-shi (JP)

(21) Appl. No.: 15/249,871

(22) Filed: Aug. 29, 2016

(30) Foreign Application Priority Data
Oct. 28, 2015 (JP) 2015-211859

(51) Int. Cl. C25D 11/24; F02F 3/00

(52) U.S. Cl. CPC C25D 11/246; F02F 3/0084; F02F 2200/00

(57) ABSTRACT

A method for manufacturing a piston for an internal combustion engine, a base material of the piston being an aluminum alloy, a cavity being formed in a top surface of the piston, includes a depositing step of depositing a porous anodic oxide coating on a portion of a surface of the base material, the portion corresponding to a wall surface of the cavity, a reinforcing step of reinforcing the anodic oxide coating deposited by the depositing step, a polishing step of forming a smoothed surface of the anodic oxide coating by polishing the anodic oxide coating reinforced by the reinforcing step, and a sealing step of applying a sealant on the smoothed surface of the anodic oxide coating formed by the polishing step.

### BACKGROUND

Technical Field

The present application relates to a method for manufacturing a piston for an internal combustion engine, in which a base material of the piston is an aluminum alloy, and a cavity is formed in a top surface of the piston.

Background Art

A method for manufacturing a piston for an internal combustion engine, in which a base material of the piston is an aluminum alloy, and a cavity is formed in a top surface of the piston, is already known. The method for manufacturing the piston for the internal combustion engine is described, for example, in JP 2012-072745A.

According to the method for manufacturing the piston for the internal combustion engine described in JP 2012-072745A, an anodic oxide coating (porous layer) is deposited on a portion of a surface of the base material, wherein the portion corresponds to the top surface of the piston (and a wall surface of the cavity formed in the top surface). Then, pores of the anodic oxide coating (porous layer) are blocked (that is, a sealing process using a sealant is executed) by forming a coating layer on the surface of the anodic oxide coating (porous layer). Then, finishing is performed that smooths an uneven surface of the coating layer (sealant layer).

Further, in JP 2010-249008A, thickness and porosity with respect to the anodic oxide coating that is formed on an inner surface of an engine combustion chamber are described.

In addition, FIG. 6 of JP 2015-094292A shows that a surface roughness of a cavity surface and a tapered surface of the piston on which the anodic oxide coating is not formed, is made less than the surface roughness of a squish surface of the piston on which the anodic oxide coating is formed.

### Technical Problem

According to the method for manufacturing the piston for the internal combustion engine described in JP 2012-072745A, in order to increase adhesion between the anodic oxide coating (porous layer) and the coating layer (sealant layer) by an anchoring effect, an uneven pattern is formed on the surface of the base material, and consequently the surface of the anodic oxide coating (porous layer) that is formed on the surface of the base material also becomes an uneven shape.

In addition, according to the method for manufacturing the piston for the internal combustion engine described in JP 2012-072745A, the uneven surface of the coating layer (sealant layer) that is formed on the uneven surface of the anodic oxide coating (porous layer) is smoothed by finishing.

Therefore, according to the method for manufacturing the piston for the internal combustion engine described in JP 2012-072745A, after the surface of the coating layer (sealant layer) is smoothed, although the thickness of the coating layer (sealant layer) that is positioned above convex portions of the surface of the anodic oxide coating (porous layer) does not become large, the thickness of the coating layer (sealant layer) that is positioned above concave portions of the surface of the anodic oxide coating (porous layer) becomes large.

That is, according to the method for manufacturing the piston for the internal combustion engine described in JP 2012-072745A, the coating layer (sealant layer) that has thick portions is formed. Consequently, according to the method for manufacturing the piston for the internal combustion engine described in JP 2012-072745A, there is a possibility that the heat capacity of the coating layer (sealant layer) becomes greater than the heat capacity of the coating layer (sealant layer) that has a uniform and small thickness.

### SUMMARY

In view of the above described problem, an object of the present application is to provide a method for manufacturing a piston for an internal combustion engine in which the heat capacity of a sealant layer is reduced while improving the surface roughness (smoothness) of a surface of the sealant layer.

Through diligent research, the inventors of the present application have attempted to polish and smooth a surface of a porous anodic oxide coating before a sealing process using a sealant is executed, in order to reduce the heat capacity of the sealant layer. However, through diligent research, the inventors of the present application have discovered that while a polishing process is executed, the anodic oxide coating is damaged, because the porous anodic oxide coating is extremely fragile. That is, through diligent research, the inventors of the present application have discovered that while the polishing process is executed, the anodic oxide coating is damaged, and then a concave portion is formed in the surface of the anodic oxide coating.

In addition, through diligent research, the inventors of the present application have discovered that a damage of the anodic oxide coating during the polishing process is restrained, by executing a reinforcing process of the anodic oxide coating before the polishing process of the surface of the anodic oxide coating, in comparison to a case in which the reinforcing process of the anodic oxide coating is not executed.

That is, through diligent research, the inventors of the present application have discovered that a risk that the concave portion is formed in the surface of the anodic oxide coating during the polishing process is restrained, by executing the reinforcing process of the anodic oxide coating before the polishing process of the surface of the anodic oxide coating, in comparison to the case in which the reinforcing process of the anodic oxide coating is not executed.

Considering the above, the present application provides a method for manufacturing a piston for an internal combustion engine, a base material of the piston being an aluminum alloy, a cavity being formed in a top surface of the piston, comprising:

a depositing step of depositing a porous anodic oxide coating on a portion of a surface of the base material, the portion corresponding to a wall surface of the cavity;

a reinforcing step of reinforcing the anodic oxide coating that is deposited by the depositing step;

a polishing step of forming a smoothed surface of the anodic oxide coating by polishing the anodic oxide coating that is reinforced by the reinforcing step; and

a sealing step of applying a sealant on the smoothed surface of the anodic oxide coating that is formed by the polishing step.

Namely, in the method for manufacturing the piston for the internal combustion engine according to the present application, the reinforcing process of the anodic oxide coating that reinforces the anodic oxide coating is executed, before executing the polishing process of the anodic oxide coating that polishes the surface of the porous anodic oxide coating.

Therefore, according to the method for manufacturing the piston for the internal combustion engine of the present application, a risk that the anodic oxide coating is damaged during the polishing process of the anodic oxide coating is reduced in comparison to the case where the reinforcing process of the anodic oxide coating is not executed.

That is, according to the method for manufacturing the piston for the internal combustion engine of the present application, the surface roughness (smoothness) of the surface of the anodic oxide coating after the polishing process of the anodic oxide coating is improved in comparison to the case where the reinforcing process of the anodic oxide coating is not executed.

In addition, in the method for manufacturing the piston for the internal combustion engine according to the present application, in the sealing process of the anodic oxide coating, the sealant is applied on the smoothed surface of the anodic oxide coating to thereby form the sealant layer.

Consequently, in the method for manufacturing the piston for the internal combustion engine according to the present application, a smooth surface of the sealant layer is formed without executing a smoothing process (finishing) with respect to the sealant layer.

More specifically, in the method for manufacturing the piston for the internal combustion engine according to the present application, the smoothed surface of the anodic oxide coating is formed, and the smooth surface of the sealant layer is also formed.

Consequently, according to the method for manufacturing the piston for the internal combustion engine of the present application, the thickness of the sealant layer is made uniform and small, and the heat capacity of the sealant layer is reduced.

That is, according to the method for manufacturing the piston for the internal combustion engine of the present application, the heat capacity of the sealant layer is reduced while improving the surface roughness (smoothness) of the surface of the sealant layer.

In the method for manufacturing the piston for the internal combustion engine according to the present application, because the surface of the sealant layer is smoothed, the wall surface of the cavity that is formed in the top surface of the piston for the internal combustion engine is smoothed, wherein the wall surface is constituted by the surface of the sealant layer. As a result, a decrease in the combustion rate inside a combustion chamber that is defined by the wall surface of the cavity and the like is suppressed.

In addition, according to the method for manufacturing the piston for the internal combustion engine of the present application, because the thickness of the sealant layer is decreased, the heat capacity of the sealant layer is reduced. Consequently, in comparison to a case where the heat capacity of the sealant layer is large, a swing characteristic (a characteristic such that the temperature of the anodic oxide coating changes in accordance with a change in the gas temperature inside the combustion chamber, while also having a heat insulating characteristic) is improved.

According to the method for manufacturing the piston for the internal combustion engine of the present application, in the reinforcing step, the anodic oxide coating that is deposited by the depositing step may be reinforced by applying the sealant until the sealant accumulates on the surface of the anodic oxide coating that is deposited by the depositing step.

That is, in the method for manufacturing the piston for the internal combustion engine according to the present application, the sealant may be used in the reinforcing process of the anodic oxide coating and in the sealing process of the anodic oxide coating. In addition, in the reinforcing process of the anodic oxide coating, the sealant may be applied until the sealant accumulates on the surface of the porous anodic oxide coating. As a result, the entire inner wall surfaces of pores (nanopores and micropores) of the anodic oxide coating may be reinforced by the sealant that is used in the reinforcing process.

Therefore, according to the method for manufacturing the piston for the internal combustion engine of the present application, in comparison to a case where a portion that is not reinforced exists in the inner wall surfaces of the pores (nanopores and micropores) of the anodic oxide coating, the rigidity of the anodic oxide coating after the reinforcing process of the anodic oxide coating may be improved, and thus the surface roughness (smoothness) of the surface of the anodic oxide coating after the polishing process of the anodic oxide coating may be improved.

If the sealant which is accumulated on the surface of the anodic oxide coating by the reinforcing process, is not completely removed by the polishing process, a portion in which the sealant remains on upper sides of the pores (especially nanopores) of the anodic oxide coating exists, and a portion in which the sealant does not remain on upper sides of the pores (especially nanopores) of the anodic oxide coating exists, after the polishing process.

When the sealing process is executed with respect to the portion in which the sealant remains on the upper sides of the pores (especially nanopores) of the anodic oxide coating, the sealant applied by the sealing process does not pass into the pores. Consequently, the sealant layer which is formed by the sealant that is accumulated on the upper sides of the pores, becomes relatively thick.

When the sealing process is executed with respect to the portion in which the sealant does not remain on the upper sides of the pores (especially nanopores) of the anodic oxide coating, the sealant applied by the sealing process passes into the pores. Consequently, the sealant layer which is formed by the sealant that is accumulated on the upper sides of the pores, becomes relatively thin.

That is, if the portion in which the sealant remains on the upper sides of the pores (especially nanopores) of the anodic oxide coating exists, and the portion in which the sealant does not remain on the upper sides of the pores (especially nanopores) of the anodic oxide coating exists after the polishing process, there is a possibility that the smoothness of the surface of the sealant layer decreases after the sealing process.

Considering the above, according to the method for manufacturing the piston for the internal combustion engine of the present application, in the polishing step, the sealant that is accumulated on the surface of the anodic oxide coating by the reinforcing step may be removed by polishing.

That is, in the method for manufacturing the piston for the internal combustion engine according to the present application, the sealant that is accumulated on the surface of the anodic oxide coating by the reinforcing process of the anodic oxide coating may be removed by polishing during the polishing process of the anodic oxide coating.

Consequently, in the method for manufacturing the piston for the internal combustion engine according to the present application, the possibility that the smoothness of the surface of the sealant layer decreases after the sealing process may be restrained.

According to the method for manufacturing the piston for the internal combustion engine of the present application, in the reinforcing step, the anodic oxide coating that is deposited by the depositing step may be reinforced by applying the sealant. In addition, the same sealant may be used in the reinforcing step and the sealing step.

That is, in the method for manufacturing the piston for the internal combustion engine according to the present application, the sealant may be used in the reinforcing process of the anodic oxide coating and in the sealing process of the anodic oxide coating.

If the sealant is used in the reinforcing process of the anodic oxide coating and in the sealing process of the anodic oxide coating, after the piston for the internal combustion engine is completed, the sealant used in the reinforcing process of the anodic oxide coating and the sealant used in the sealing process of the anodic oxide coating remain inside the pores of the anodic oxide coating.

Considering the above, according to the method for manufacturing the piston for the internal combustion engine of the present application, the same sealant may be used in the reinforcing process of the anodic oxide coating and in the sealing process of the anodic oxide coating.

Consequently, in the method for manufacturing the piston for the internal combustion engine according to the present application, in comparison to a case where different sealant is used in the reinforcing process of the anodic oxide coating and in the sealing process of the anodic oxide coating, the adhesion between the sealant for the reinforcing process and the sealant for the sealing process that remain inside the pores of the anodic oxide coating after completion of the piston for the internal combustion engine may be improved.

Also, in the method for manufacturing the piston for the internal combustion engine according to the present application, the coefficient of thermal expansion of the sealant for the reinforcing process that remains inside the pores of the anodic oxide coating after the completion of the piston for the internal combustion engine and the coefficient of thermal expansion of the sealant for the sealing process that remains inside the pores of the anodic oxide coating after the completion of the piston for the internal combustion engine may be made equal.

According to the method for manufacturing the piston for the internal combustion engine of the present application, in the reinforcing step, the anodic oxide coating that is deposited by the depositing step may be reinforced by applying a sealant. In addition, a viscosity of the sealant that is used in the reinforcing step may be less than a viscosity of the sealant that is used in the sealing step.

That is, in the method for manufacturing the piston for the internal combustion engine according to the present application, the sealant may be used in the reinforcing process of the anodic oxide coating and in the sealing process of the anodic oxide coating. The viscosity of the sealant that is used in the reinforcing process of the anodic oxide coating may be less than the viscosity of the sealant that is used in the sealing process of the anodic oxide coating.

Consequently, in the method for manufacturing the piston for the internal combustion engine according to the present application, in comparison to a case in which the sealant having a large viscosity is used in the reinforcing process of the anodic oxide coating, the sealant for the reinforcing process may be reliably caused to impregnate to a deep portion (portion that is apart from the surface of the anodic oxide coating) of the pores (nanopores and micropores) of the anodic oxide coating during the reinforcing process of the anodic oxide coating, and thereby the rigidity of the anodic oxide coating after the reinforcing process of the anodic oxide coating may be improved.

In the method for manufacturing the piston for the internal combustion engine according to the present application, the viscosity of the sealant that is used in the sealing process of the anodic oxide coating may be larger than the viscosity of the sealant that is used in the reinforcing process of the anodic oxide coating.

Consequently, in the method for manufacturing the piston for the internal combustion engine according to the present application, in comparison to a case in which the sealant having a small viscosity is used in the sealing process of the anodic oxide coating, it may become difficult for the sealant for the reinforcing process to impregnate to the deep portion (portion that is apart from the surface of the anodic oxide coating) of the pores (nanopores and micropores) of the anodic oxide coating during the sealing process of the anodic oxide coating. As a result, a space (air layer) remaining inside the pores of the anodic oxide coating after the completion of the piston for the internal combustion engine may be increased, and thereby the heat insulating characteristic of the piston for the internal combustion engine may be improved.

According to the present application, the heat capacity of the sealant layer is reduced while improving the surface roughness (smoothness) of the surface of the sealant layer.

### BRIEF DESCRIPTION OF THE DRAWINGS

FIG. 1 is a schematic cross-sectional view of a piston 10 for an internal combustion engine that is manufactured by a method for manufacturing a piston for an internal combustion engine according to a first embodiment;

FIG. 2A shows a base material 10b of the piston 10 for the internal combustion engine in the method for manufacturing the piston for the internal combustion engine according to the first embodiment;

FIG. 2B shows a deposition process in the method for manufacturing the piston for the internal combustion engine according to the first embodiment;

FIG. 3A shows a reinforcing process in the method for manufacturing the piston for the internal combustion engine according to the first embodiment;

FIG. 3B shows a polishing process in the method for manufacturing the piston for the internal combustion engine according to the first embodiment;

FIG. 3C shows a sealing process in the method for manufacturing the piston for the internal combustion engine according to the first embodiment;

FIG. 4A is an enlarged view of FIG. 2B;

FIG. 4B shows a state in which a sealant 10d in solution form is applied on the anodic oxide coating 10c;

FIG. 4C shows a state after the sealant 10d in solution form shown in FIG. 4B is cured;

FIG. 4D shows a state after the polishing process is executed;

FIG. 4E shows a state in which a sealant 10f in solution form is applied on the anodic oxide coating 10c;

FIG. 4F shows a state after the sealant 10f in solution form shown in FIG. 4E is cured;

FIG. 5A shows a deposition process in a comparative example;

FIG. 5B shows a state after a polishing process is executed in the comparative example;

FIG. 5C shows a sealing process in the comparative example;

FIG. 6A is a view for describing the arithmetic average roughness Ra;

FIG. 6B is a view for describing the maximum height roughness Rp;

FIG. 6C is a view for describing the ten-point average roughness Rzjis;

FIG. 7A is a view for describing a comparison between the arithmetic average roughness Ra of a wall surface 10a1a of a cavity 10a1 according to the method for manufacturing the piston for the internal combustion engine of the first embodiment, and that of the wall surface 10a1a of the cavity 10a1 according to the method for manufacturing the piston for the internal combustion engine of the comparative example;

FIG. 7B is a view for describing a comparison between the maximum height roughness Rp of a wall surface 10a1a of a cavity 10a1 according to the method for manufacturing the piston for the internal combustion engine of the first embodiment, and that of the wall surface 10a1a of the cavity 10a1 according to the method for manufacturing the piston for the internal combustion engine of the comparative example;

FIG. 7C is a view for describing a comparison between the ten-point average roughness Rzjis of a wall surface 10a1a of a cavity 10a1 according to the method for manufacturing the piston for the internal combustion engine of the first embodiment, and that of the wall surface 10a1a of the cavity 10a1 according to the method for manufacturing the piston for the internal combustion engine of the comparative example; and

FIG. 8 is a view for describing a rate of fuel consumption improvement that is achieved by the piston 10 for an internal combustion engine that is manufactured by the method for manufacturing the piston for the internal combustion engine according to the first embodiment.

### DETAILED DESCRIPTION

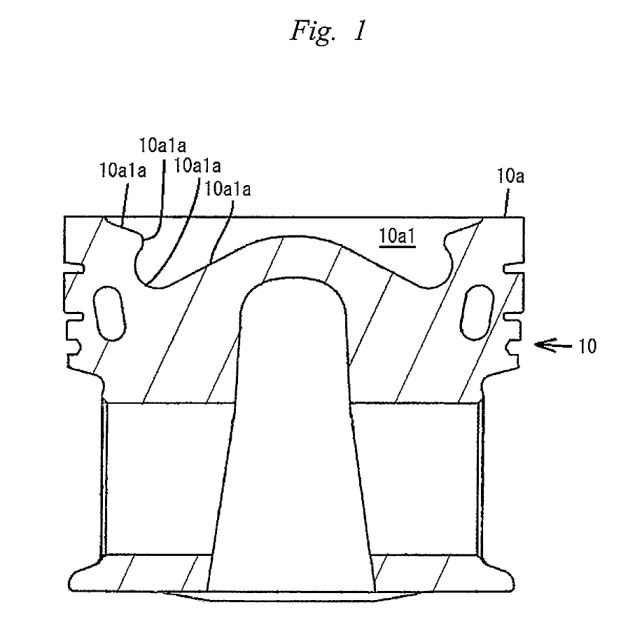

Hereunder, a first embodiment of a method for manufacturing a piston for an internal combustion engine according to the present application is described. FIG. 1 is a schematic cross-sectional view of a piston 10 for an internal combustion engine that is manufactured by the method for manufacturing the piston for the internal combustion engine according to the first embodiment.

The piston 10 for an internal combustion engine that is manufactured by the method for manufacturing the piston for the internal combustion engine of the first embodiment adopts an aluminum alloy as a base material. Further, as illustrated in FIG. 1, a cavity 10a1 is formed in a top surface 10a of the piston 10 for an internal combustion engine.

According to the method for manufacturing the piston for the internal combustion engine of the first embodiment, processes that are described later are executed with respect to the base material of the piston 10 for an internal combustion engine to improve the smoothness of a wall surface 10a1a of the cavity 10a1.

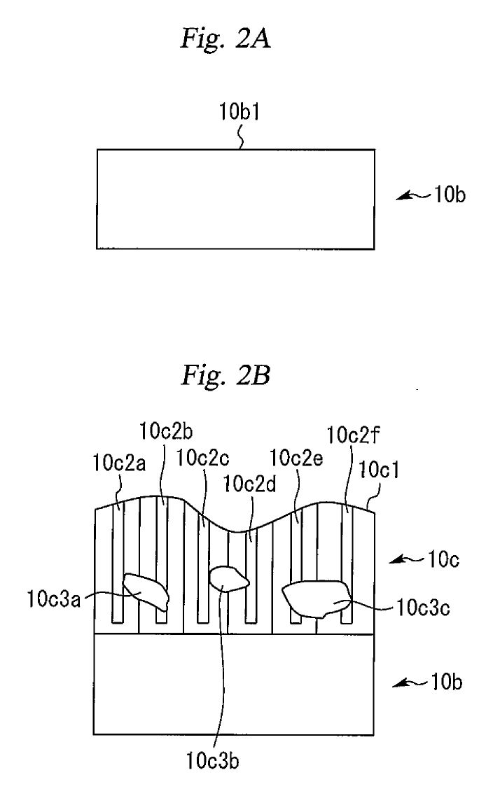

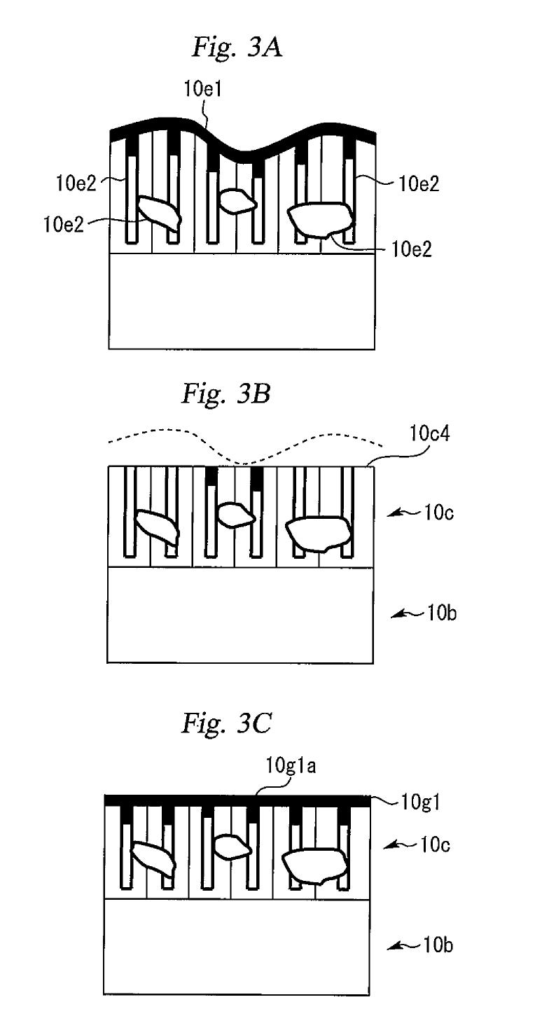

FIG. 2 and FIG. 3 are views for describing processes that are executed with respect to a base material 10b of the piston 10 for an internal combustion engine in the method for manufacturing the piston for the internal combustion engine of the first embodiment. More specifically, FIG. 2A, FIG. 2B, FIG. 3A, FIG. 3B and FIG. 3C are enlarged cross-sectional views of a portion of the wall surface 10a1a of the cavity 10a1 during execution of the respective processes.

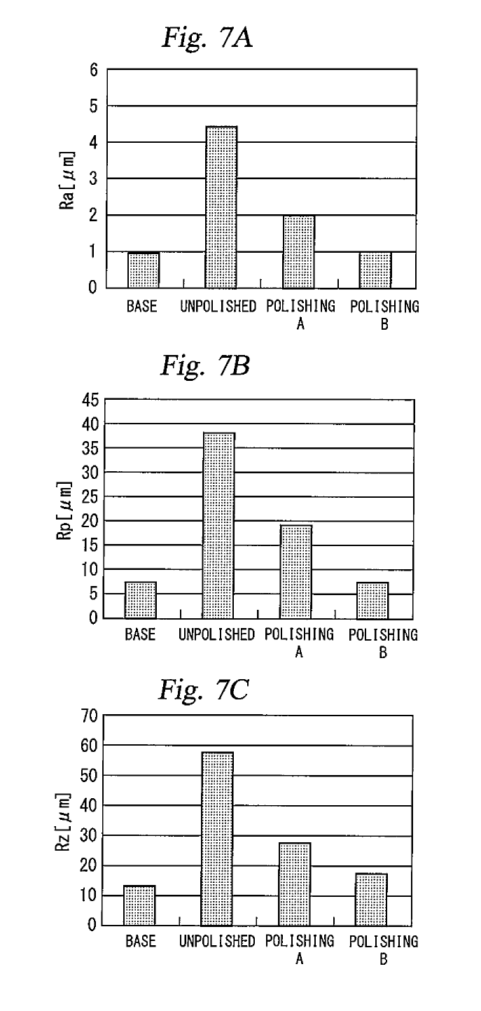

In the method for manufacturing the piston for the internal combustion engine of the first embodiment, first, as illustrated in FIG. 2A, a base material 10b made of an aluminum alloy that has a smooth surface 10b1 is prepared. In an example illustrated in FIG. 7A that is described later, of the surface 10b1 of the base material 10b, an arithmetic average roughness Ra (corresponds to the arithmetic average roughness Ra for “base” in FIG. 7A) of a portion corresponding to the wall surface 10a1a (see FIG. 1) of the cavity 10a1 (see FIG. 1) is set to, for example, approximately 0.9 to 1 μm.

Next, in the method for manufacturing the piston for the internal combustion engine of the first embodiment, as illustrated in FIG. 2B, a deposition process (anodic oxidation process; alumite) that deposits a porous anodic oxide coating 10c is executed on a portion of the surface 10b1 of the base material 10b that corresponds to the wall surface 10a1a of the cavity 10a1. In the example illustrated in FIG. 7A that is described later, the arithmetic average roughness Ra (corresponds to the arithmetic average roughness Ra for “unpolished” in FIG. 7A) of the surface 10c1 of the anodic oxide coating 10c after execution of the deposition process is, for example, approximately 4 to 5 μm.

The anodic oxide coating 10c deposited by the deposition process that is illustrated in FIG. 2B has a large number of nanopores 10c2a, 10c2b, 10c2c, 10c2d, 10c2e and 10c2f and a large number of micropores 10c3a, 10c3b and 10c3c. Consequently, the anodic oxide coating 10c deposited by the deposition process that is illustrated in FIG. 2B is fragile with respect to a polishing process that is described later.

Therefore, in the method for manufacturing the piston for the internal combustion engine of the first embodiment, next, a reinforcing process is executed that reinforces the anodic oxide coating 10c deposited by the deposition process that is illustrated in FIG. 2B. Specifically, in the reinforcing process that is illustrated in FIG. 3A, sealant layers 10e1 and 10e2 are formed on the anodic oxide coating 10c deposited by the deposition process that is illustrated in FIG. 2B.

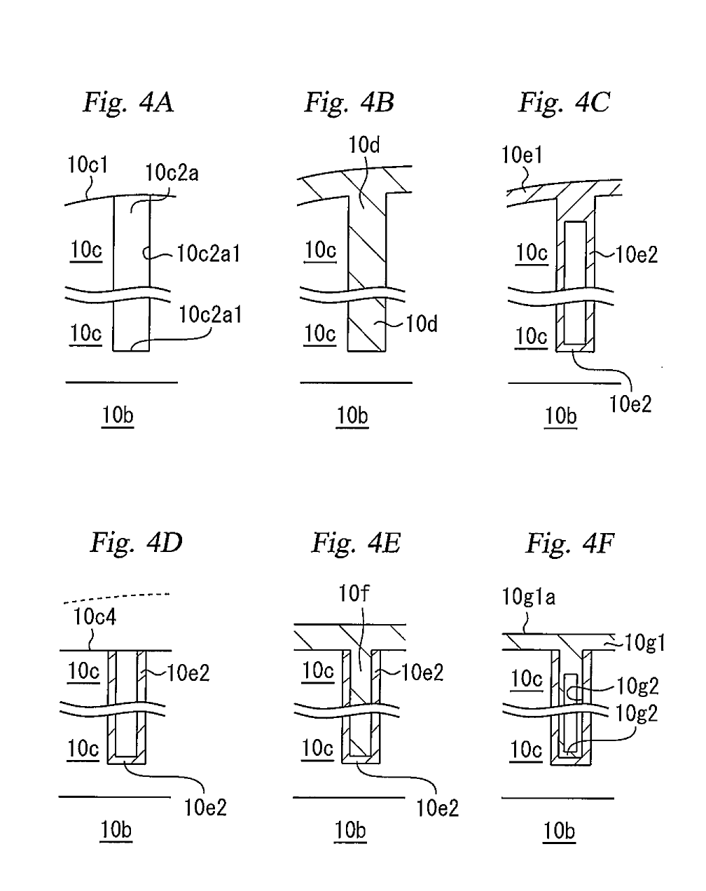

FIG. 4 is a view for describing the reinforcing process and the like that forms the sealant layers 10e1 and 10e2 illustrated in FIG. 3A, which is a view that shows, in an enlarged manner, the nanopore 10c2a illustrated in FIG. 2B.

In the method for manufacturing the piston for the internal combustion engine of the first embodiment, to form the sealant layers 10e1 and 10e2 illustrated in FIG. 3A, first, as illustrated in FIG. 4A and FIG. 4B, a sealant 10d in solution form is applied on the anodic oxide coating 10c, and as a result the sealant 10d in solution form is filled into the nanopore 10c2a having an inner wall surface 10c2a1 and also accumulates on the surface 10c1 of the anodic oxide coating 10c.

More specifically, the sealant 10d in solution form is applied on the anodic oxide coating 10c, and as a result the sealant 10d in solution form is filled into the nanopores 10c2b, 10c2c, 10c2d, 10c2e and 10c2f (see FIG. 2B) and the micropores 10c3a, 10c3b and 10c3c (see FIG. 2B), and also accumulates on the surface 10c1 of the anodic oxide coating 10c that corresponds to the wall surface 10a1a (see FIG. 1) of the cavity 10a1 (see FIG. 1).

During the course of the sealant 10d in solution form being supplied, air bubbles that come out from the nanopores 10c2a, 10c2b, 10c2c, 10c2d, 10c2e and 10c2f and the micropores 10c3a, 10c3b and 10c3c stop being present on the surface 10c1 of the anodic oxide coating 10c, and when a gloss appears it can be determined that filling of the sealant 10d into the nanopores 10c2a, 10c2b, 10c2c, 10c2d, 10c2e and 10c2f and the micropores 10c3a, 10c3b and 10c3c is completed and that the sealant 10d has started to accumulate on the surface 10c1 of the anodic oxide coating 10c. In practice, an application amount of the sealant 10d that will accumulate up to the surface is first determined as described below, and the relevant application amount of the sealant 10d is then applied.

The supply amount (application amount) of the sealant 10d, for example, is calculated based on the average capacity of the pores in the anodic oxide coating 10c.

Next, as illustrated in FIG. 4B and FIG. 4C, by curing of the sealant 10d in solution form (more specifically, by reaction and the evaporation of an organic solvent as described later), the sealant layer 10e2 is formed on the inner wall surface 10c2a1 (see FIG. 4A) of the nanopore 10c2a (see FIG. 4A), and the sealant layer 10e1 is also formed on the surface 10c1 (see FIG. 4A) of the anodic oxide coating 10c.

Likewise, as illustrated in FIG. 3A, the sealant layer 10e2 is also formed on the inner wall surface of the nanopores 10c2b, 10c2c, 10c2d, 10c2e and 10c2f (see FIG. 2B) and the micropores 10c3a, 10c3b and 10c3c (see FIG. 2B), and the sealant layer 10e1 is formed on the surface 10c1 (see FIG. 2B) of the anodic oxide coating 10c (see FIG. 2B) that corresponds to the wall surface 10a1a (see FIG. 1) of the cavity 10a1 (see FIG. 1).

As a result, the anodic oxide coating 10c is reinforced, and damage of the anodic oxide coating 10c during execution of a polishing process that is described later is avoided.

Next, in the method for manufacturing the piston for the internal combustion engine of the first embodiment, as illustrated in FIG. 3B, by polishing the anodic oxide coating 10c that is reinforced by the reinforcing process illustrated in FIG. 3A, a polishing process is executed that forms a smoothed surface 10c4 of the anodic oxide coating 10c. In an example illustrated in FIG. 7A that is described later, the arithmetic average roughness Ra (corresponds to arithmetic average roughness Ra for “polishing B” in FIG. 7A) of the smoothed surface 10c4 of the anodic oxide coating 10c is, for example, approximately 1 μm.

More specifically, in the method for manufacturing the piston for the internal combustion engine of the first embodiment, the sealant layer 10e1 (see FIG. 4C) that is formed on the surface 10c1 of the anodic oxide coating 10c by accumulating the sealant 10d in solution form (see FIG. 4B) on the surface 10c1 (see FIG. 4A) of the anodic oxide coating 10c (see FIG. 4A) is removed by polishing in the polishing process illustrated in FIG. 3B and FIG. 4D.

Likewise, the sealant layer 10e1 (see FIG. 3A) that is formed on the surface 10c1 of the anodic oxide coating 10c by accumulating the sealant 10d in solution form (see FIG. 4B) on the surface 10c1 (see FIG. 2B) of the anodic oxide coating 10c (see FIG. 2B) is removed by polishing in the polishing process illustrated in FIG. 3B.

Next, in the method for manufacturing the piston for the internal combustion engine of the first embodiment, a sealing process is executed that applies a sealant 10f (see FIG. 4E) on the smoothed surface 10c4 of the anodic oxide coating 10c that is formed by the polishing process illustrated in FIG. 3B. Specifically, in the sealing process illustrated in FIG. 3C, a sealant layer 10g1 is formed on the smoothed surface 10c4 of the anodic oxide coating 10c that is formed by the polishing process illustrated in FIG. 3B.

In the method for manufacturing the piston for the internal combustion engine of the first embodiment, in order to form the sealant layer 10g1 illustrated in FIG. 3C, first, as illustrated in FIG. 4E, the sealant 10f in solution form is applied on the anodic oxide coating 10c. As a result, the sealant 10f in solution form is filled into the nanopore 10c2a (see FIG. 4A) and also accumulates on the smoothed surface 10c4 (see FIG. 4D) of the anodic oxide coating 10c.

More specifically, the sealant 10f in solution form is applied on the anodic oxide coating 10c, and as a result the sealant 10f in solution form is filled into the nanopores 10c2b, 10c2c, 10c2d, 10c2e and 10c2f (see FIG. 2B) and the micropores 10c3a, 10c3b and 10c3c (see FIG. 2B), and also accumulates on the smoothed surface 10c4 (see FIG. 3B) of the anodic oxide coating 10c that corresponds to the wall surface 10a1a (see FIG. 1) of the cavity 10a1 (see FIG. 1).

During the course of the sealant 10f in solution form being supplied, air bubbles that come out from the nanopores 10c2a, 10c2b, 10c2c, 10c2d, 10c2e and 10c2f and the micropores 10c3a, 10c3b and 10c3c stop being present on the surface 10c1 of the anodic oxide coating 10c, and when a gloss appears it can be determined that filling of the sealant 10f into the nanopores 10c2a, 10c2b, 10c2c, 10c2d, 10c2e and 10c2f and the micropores 10c3a, 10c3b and 10c3c is completed and that the sealant 10f has started to accumulate on the surface 10c1 of the anodic oxide coating 10c.

The supply amount of the sealant 10f, for example, is calculated based on the average capacity of the pores in the anodic oxide coating 10c.

Next, as illustrated in FIG. 4E and FIG. 4F, a sealant layer 10g2 is formed on the inner wall surface 10c2a1 (see FIG. 4A) of the nanopore 10c2a (see FIG. 4A) by curing of the sealant 10f in solution form (more specifically, by reaction and the evaporation of an organic solvent as described later), and the sealant layer 10g1 is also formed on the smoothed surface 10c4 (see FIG. 4D) of the anodic oxide coating 10c, and an entrance portion of the nanopore 10c2a is blocked up by the sealant layer 10g1.

Likewise, as illustrated in FIG. 3C, the sealant layer is also formed on the inner wall surface of the nanopores 10c2b, 10c2c, 10c2d, 10c2e and 10c2f (see FIG. 2B) and the micropores 10c3a, 10c3b and 10c3c (see FIG. 2B), the sealant layer 10g1 is formed on the smoothed surface 10c4 (see FIG. 3B) of the anodic oxide coating 10c that corresponds to the wall surface 10a1a (see FIG. 1) of the cavity 10a1 (see FIG. 1), and an entrance portion of the nanopores 10c2b, 10c2c, 10c2d, 10c2e and 10c2f is blocked up by the sealant layer 10g1.

In other words, in the method for manufacturing the piston for the internal combustion engine of the first embodiment, the reinforcing process illustrated in FIG. 3A that reinforces the anodic oxide coating 10c is executed before executing the polishing process illustrated in FIG. 3B that polishes the surface of the porous anodic oxide coating 10c.

Therefore, according to the method for manufacturing the piston for the internal combustion engine of the first embodiment, the risk of the anodic oxide coating 10c being damaged during execution of the polishing process illustrated in FIG. 3B can be reduced in comparison to a case where the reinforcing process illustrated in FIG. 3A is not executed.

That is, according to the method for manufacturing the piston for the internal combustion engine of the first embodiment, the surface roughness (smoothness) of the smoothed surface 10c4 of the anodic oxide coating 10c after execution of the polishing process illustrated in FIG. 3B can be improved in comparison to a case where the reinforcing process illustrated in FIG. 3A is not executed.

In addition, in the method for manufacturing the piston for the internal combustion engine of the first embodiment, in the sealing process illustrated in FIG. 3C, the sealant 10f (see FIG. 4E) is applied on the smoothed surface 10c4 (see FIG. 3B) of the anodic oxide coating 10c to thereby form the sealant layer 10g1.

Consequently, in the method for manufacturing the piston for the internal combustion engine of the first embodiment, a smooth surface 10g1a of the sealant layer 10g1 can be formed without executing a smoothing process (finishing) on the sealant layer 10g1.

More specifically, in the method for manufacturing the piston for the internal combustion engine of the first embodiment, the smoothed surface 10c4 of the anodic oxide coating 10c is formed as illustrated in FIG. 3B, and the smooth surface 10g1a of the sealant layer 10g1 is also formed as illustrated in FIG. 3C.

Consequently, according to the method for manufacturing the piston for the internal combustion engine of the first embodiment, the thickness of the sealant layer 10g1 can be made uniform and small, and the heat capacity of the sealant layer 10g1 can be reduced. That is, according to the method for manufacturing the piston for the internal combustion engine of the first embodiment, the heat capacity of the sealant layer 10g1 can be reduced while improving the surface roughness (smoothness) of the surface 10g1a of the sealant layer 10g1. In an example illustrated in FIG. 7A that is described later, the arithmetic average roughness Ra of the surface 10g1a of the sealant layer 10g1 (corresponds to the arithmetic average roughness Ra for “polishing B” in FIG. 7A) is, for example, 1 μm.

In the method for manufacturing the piston for the internal combustion engine of the first embodiment, since the surface 10g1a of the sealant layer 10g1 illustrated in FIG. 3C can be smoothed, the wall surface 10a1a of the cavity 10a1 that is formed in the top surface 10a of the piston 10 for an internal combustion engine as illustrated in FIG. 1 that is constituted by the surface 10g1a of the sealant layer 10g1 can be smoothed. As a result, a decrease in the combustion rate inside a combustion chamber (not illustrated in the drawings) that is defined by the wall surface 10a1a of the cavity 10a1 and the like can be suppressed. More specifically, by smoothing the wall surface 10a1a of the cavity 10a1, the growth of a flame inside the combustion chamber can be promoted and the combustion rate can be improved.

In addition, according to the method for manufacturing the piston for the internal combustion engine of the first embodiment, because the thickness of the sealant layer 10g1 illustrated in FIG. 3C can be decreased, the heat capacity of the sealant layer 10g1 can be reduced. Consequently, in comparison to a case where the heat capacity of the sealant layer 10g1 is large, a swing characteristic (a characteristic such that the temperature of the anodic oxide coating 10c changes in accordance with a change in the gas temperature inside the combustion chamber, while also having a heat insulating characteristic) can be improved.

Further, in the method for manufacturing the piston for the internal combustion engine of the first embodiment, as illustrated in FIG. 4B and FIG. 4E, the sealants 10d and 10f are used in the reinforcing process illustrated in FIG. 3A and the sealing process illustrated in FIG. 3C. In addition, in the reinforcing process illustrated in FIG. 3A, as illustrated in FIG. 4B, the sealant 10d is applied until the sealant 10d accumulates on the surface 10c1 (see FIG. 4A) of the porous anodic oxide coating 10c. As a result, the entire inner wall surfaces of the respective nanopores 10c2a, 10c2b, 10c2c, 10c2d, 10c2e and 10c2f (see FIG. 2B) and the respective micropores 10c3a, 10c3b and 10c3c (see FIG. 2B) of the anodic oxide coating 10c are reinforced by the sealant 10d that is used in the reinforcing process.

Therefore, according to the method for manufacturing the piston for the internal combustion engine of the first embodiment, in comparison to a case where a portion that is not reinforced exists in the inner wall surfaces of the respective nanopores 10c2a, 10c2b, 10c2c, 10c2d, 10c2e and 10c2f and the respective micropores 10c3a, 10c3b and 10c3c of the anodic oxide coating 10c, the rigidity of the anodic oxide coating 10c after execution of the reinforcing process illustrated in FIG. 3A can be improved, and thus the surface roughness (smoothness) of the smoothed surface 10c4 of the anodic oxide coating 10c after execution of the polishing process illustrated in FIG. 3B can be improved.

If a case is assumed in which the sealant 10d (see FIG. 4B) that is applied by the reinforcing process illustrated in FIG. 3A is present on the smoothed surface 10c4 (see FIG. 3B and FIG. 4D) of the anodic oxide coating 10c before executing the sealing process illustrated in FIG. 3C, the sealant 10f (see FIG. 4E) applied by the sealing process illustrated in FIG. 3C would accumulate on the smoothed surface 10c4 of the anodic oxide coating 10c without impregnating into the nanopores 10c2a, 10c2b, 10c2c, 10c2d, 10c2e and 10c2f (see FIG. 2B) and the micropores 10c3a, 10c3b and 10c3c (see FIG. 2B) of the anodic oxide coating 10c, and as a result there would thus be a risk of the sealant layer 10g1 (see FIG. 3C and FIG. 4F) formed on the smoothed surface 10c4 of the anodic oxide coating 10c becoming thicker and the heat capacity of the sealant layer 10g1 increasing.

In view of the above point, in the method for manufacturing the piston for the internal combustion engine of the first embodiment, the sealant 10d (see FIG. 4B) that is accumulated on the surface 10c1 (see FIG. 2B) of the anodic oxide coating 10c by the reinforcing process illustrated in FIG. 3A (more specifically, the sealant layer 10e1 (see FIG. 3A and FIG. 4C) formed after the sealant 10d cures) is removed by polishing during the polishing process illustrated in FIG. 3B.

Therefore, according to the method for manufacturing the piston for the internal combustion engine of the first embodiment, the risk of the sealant layer 10g1 that is formed on the smoothed surface 10c4 of the anodic oxide coating 10c becoming thick and the heat capacity of the sealant layer 10g1 increasing can be reduced.

As described above, in the method for manufacturing the piston for the internal combustion engine of the first embodiment the sealants 10d and 10f (see FIG. 4B and FIG. 4E) are used in the reinforcing process illustrated in FIG. 3A and the sealing process illustrated in FIG. 3C.

In this connection, in a case where the method for manufacturing the piston for the internal combustion engine of the first embodiment are used in the reinforcing process illustrated in FIG. 3A and the sealing process illustrated in FIG. 3C, after completion of the piston 10 for an internal combustion engine (see FIG. 1), the sealant 10d used in the reinforcing process illustrated in FIG. 3A and the sealant 10f used in the sealing process illustrated in FIG. 3C cure to become the sealant layers 10e2 and 10g2 as illustrated in FIG. 4E and FIG. 4F, and remain inside the nanopores 10c2a, 10c2b, 10c2c, 10c2d, 10c2e and 10c2f (see FIG. 2B) and the micropores 10c3a, 10c3b and 10c3c (see FIG. 2B) of the anodic oxide coating 10c.

In view of the above point, in the method for manufacturing the piston for the internal combustion engine of the first embodiment, the sealants 10d and 10f that are identical (see FIG. 4B and FIG. 4E) are used in the reinforcing process illustrated in FIG. 3A and the sealing process illustrated in FIG. 3C (that is, the sealant 10d and the sealant 10f are the same kind of sealant (the same material and the same viscosity)).

Therefore, according to the method for manufacturing the piston for the internal combustion engine of the first embodiment, in comparison to a case where different sealants are used in for the reinforcing process illustrated in FIG. 3A and the sealing process illustrated in FIG. 3C, the adherence between the sealant 10d (more specifically, the sealant layer 10e2) and the sealant 10f (more specifically, the sealant layer 10g2) that remain inside the nanopores 10c2a, 10c2b, 10c2c, 10c2d, 10c2e and 10c2f (see FIG. 2B) and the micropores 10c3a, 10c3b and 10c3c (see FIG. 2B) of the anodic oxide coating 10c after completion of the piston 10 for an internal combustion engine (see FIG. 1) can be improved.

Further, according to the method for manufacturing the piston for the internal combustion engine of the first embodiment, the coefficient of thermal expansion of the sealant 10d (more specifically, the sealant layer 10e2) that remains inside the nanopores 10c2a, 10c2b, 10c2c, 10c2d, 10c2e and 10c2f and the micropores 10c3a, 10c3b and 10c3c of the anodic oxide coating 10c after completion of the piston 10 for an internal combustion engine and the coefficient of thermal expansion of the sealant 10f (more specifically, the sealant layer 10g2) that remains inside the nanopores 10c2a, 10c2b, 10c2c, 10c2d, 10c2e and 10c2f and the micropores 10c3a, 10c3b and 10c3c of the anodic oxide coating 10c after completion of the piston 10 for an internal combustion engine can be made identical.

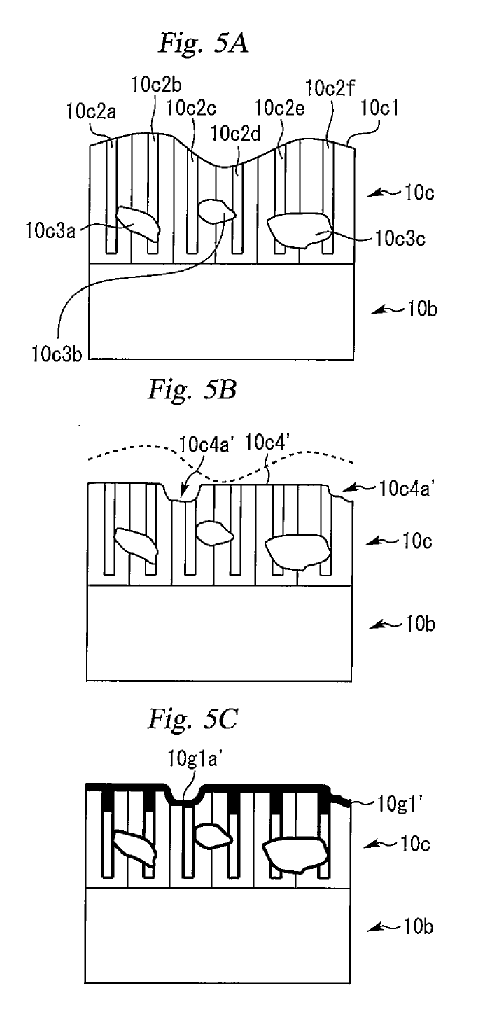

FIG. 5 is a view for describing processes that are executed with respect to the base material 10b of the piston 10 for an internal combustion engine in a method for manufacturing the piston for the internal combustion engine according to a comparative example. More specifically, FIG. 5A, FIG. 5B and FIG. 5C are enlarged cross-sectional views of a portion of the wall surface 10a1a of the cavity 10a1 during execution of respective processes of the comparative example.

In the method for manufacturing the piston for the internal combustion engine of the comparative example, first, as illustrated in FIG. 2A, a base material 10b made of an aluminum alloy that has a smooth surface 10b1 is prepared. The arithmetic average roughness Ra of a portion of the surface 10b1 of the base material 10b that corresponds to the wall surface 10a1a (see FIG. 1) of the cavity 10a1 (see FIG. 1) is set to, for example, approximately 0.9 to 1 μm.

Next, in the method for manufacturing the piston for the internal combustion engine of the comparative example, as illustrated in FIG. 5A, a deposition process that deposits a porous anodic oxide coating 10c is executed on a portion of the surface 10b1 of the base material 10b that corresponds to the wall surface 10a1a of the cavity 10a1. The arithmetic average roughness Ra of the surface 10c1 of the anodic oxide coating 10c after execution of the deposition process is, for example, approximately 4 to 5 μm.

The anodic oxide coating 10c deposited by the deposition process illustrated in FIG. 5A has a large number of nanopores 10c2a, 10c2b, 10c2c, 10c2d, 10c2e and 10c2f and a large number of micropores 10c3a, 10c3b and 10c3c. Therefore, the anodic oxide coating 10c deposited by the deposition process that is illustrated in FIG. 5A is fragile with respect to a polishing process illustrated in FIG. 5B.

Next, in the method for manufacturing the piston for the internal combustion engine of the comparative example, as illustrated in FIG. 5B, a polishing process that polishes the anodic oxide coating 10c is executed. However, because the porous anodic oxide coating 10c is extremely fragile, during execution of the polishing process illustrated in FIG. 5B, the anodic oxide coating 10c is damaged and a concave portion 10c4a′ is formed on a surface 10c4′ of the anodic oxide coating 10c. In an example illustrated in FIG. 7A that is described later, the arithmetic average roughness Ra of the surface 10c4′ of the anodic oxide coating 10c (corresponds to the arithmetic average roughness Ra of “polishing A” in FIG. 7A) is, for example, approximately 2 μm.

Next, in the method for manufacturing the piston for the internal combustion engine of the comparative example, a sealing process is executed that applies a sealant 10f (see FIG. 4E) on the surface 10c4′ of the anodic oxide coating 10c that is formed by the polishing process illustrated in FIG. 5B. Specifically, in the sealing process illustrated in FIG. 5C, a sealant layer 10g1′ is formed on the surface 10c4′ of the anodic oxide coating 10c that is formed by the polishing process illustrated in FIG. 5B.

In the method for manufacturing the piston for the internal combustion engine of the comparative example, to form a sealant layer 10g1′ illustrated in FIG. 5C, first, as illustrated in FIG. 4E, the sealant 10f in solution form is applied on the anodic oxide coating 10c, and as a result the sealant 10f in solution form is filled into the nanopore 10c2a (see FIG. 4A) and also accumulates on the surface 10c4′ (see FIG. 5B) of the anodic oxide coating 10c.

More specifically, the sealant 10f in solution form is applied on the anodic oxide coating 10c, and as a result the sealant 10f in solution form is filled into the nanopores 10c2b, 10c2c, 10c2d, 10c2e and 10c2f (see FIG. 5A) and the micropores 10c3a, 10c3b and 10c3c (see FIG. 5A), and also accumulates on the surface 10c4′ (see FIG. 5B) of the anodic oxide coating 10c that corresponds to the wall surface 10a1a (see FIG. 1) of the cavity 10a1 (see FIG. 1).

Next, in the method for manufacturing the piston for the internal combustion engine of the comparative example, by curing of the sealant 10f in solution form (see FIG. 4E), as illustrated in FIG. 5C, the sealant layer 10g1′ is formed on the surface 10c4′ (see FIG. 5B) of the anodic oxide coating 10c.

More specifically, in the method for manufacturing the piston for the internal combustion engine of the comparative example, as illustrated in FIG. 5C, a concave portion that corresponds to the concave portion 10c4a′ (see FIG. 5B) is formed in the surface 10g1a′ of the sealant layer 10g1′. In an example illustrated in FIG. 7A that is described later, the arithmetic average roughness Ra (corresponds to the arithmetic average roughness Ra of “polishing A” in FIG. 7A) of the surface 10g1a′ of the sealant layer 10g1′ is, for example, approximately 2 μm.

FIG. 7 is a view for describing a comparison between the surface roughness of the wall surface 10a1a of the cavity 10a1 after completion of the piston 10 for an internal combustion engine that is manufactured by the method for manufacturing the piston for the internal combustion engine of the first embodiment, and the surface roughness of the wall surface 10a1a of the cavity 10a1 after completion of the piston 10 for an internal combustion engine that is manufactured by the method for manufacturing the piston for the internal combustion engine of the comparative example. More specifically, FIG. 7A is a view showing arithmetic average roughnesses Ra, FIG. 7B is a view showing maximum height roughnesses Rp, and FIG. 7C is a view showing ten-point average roughnesses Rzjis.

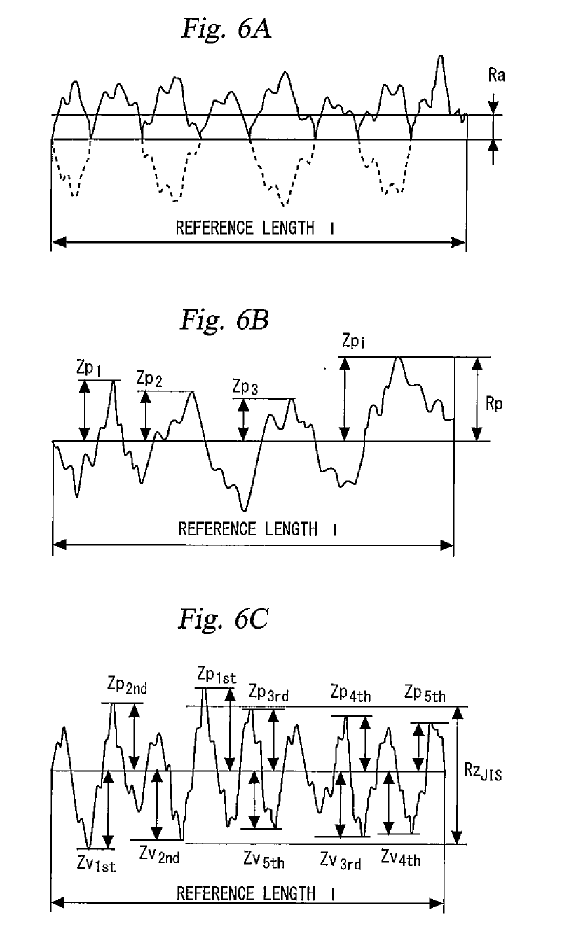

FIG. 6A is a view for describing the arithmetic average roughness Ra, FIG. 6B is a view for describing the maximum height roughness Rp, and FIG. 6C is a view for describing the ten-point average roughness Rzjis.

The arithmetic average roughness Ra, the maximum height roughness Rp and the ten-point average roughness Rzjis are surface roughness defined by the JIS (Japanese Industrial Standards).

More specifically, as illustrated in FIG. 6A, the arithmetic average roughness Ra is a numerical value that shows all peaks of a roughness curve within a measuring range (reference length 1) in a state in which the peaks are brought together within a center line, and is a numerical value which, even when a large defect is present, is less susceptible to be influenced thereby, and which is calculated by the following Expression 1.

As illustrated in FIG. 6B, the maximum height roughness Rp is a numerical value of the maximum peak height in the roughness curve within the measuring range (reference length 1), and is calculated by the following Expression 2.

As illustrated in FIG. 6C, the ten-point average roughness Rzjis is a value obtained by extracting 10 points from high peaks in the roughness curve within the measuring range (reference length 1) and taking an average value thereof, and is calculated by the following Expression 3.

$$\begin{matrix}Ra = \frac{1}{l} {\int }_{0}^{l} \vert Z ( x ) \vert d x & ( 1 ) \\ Rp = max ( Z ( x ) ) & ( 2 ) \\ Rzjis = \frac{1}{5} {\sum }_{i = 1}^{5} ( Zpj + Zvj ) & ( 3 )\end{matrix}$$

In the example illustrated in FIG. 7A, the arithmetic average roughness Ra of the surface 10b1 (see FIG. 2A) of the base material 10b (see FIG. 2A) according to the method for manufacturing the piston for the internal combustion engine of the first embodiment corresponds to a numerical value for “base”, and is approximately 0.9 to 1 μm. Further, the arithmetic average roughness Ra of the surface 10c1 (see FIG. 2B) of the anodic oxide coating 10c (see FIG. 2B) after execution of the deposition process in the method for manufacturing the piston for the internal combustion engine of the first embodiment corresponds to a numerical value for “unpolished”, and is approximately 4 to 5 μm. In addition, the arithmetic average roughness Ra of the smoothed surface 10c4 (see FIG. 3B) of the anodic oxide coating 10c (see FIG. 3B) according to the method for manufacturing the piston for the internal combustion engine of the first embodiment corresponds to a numerical value for “polishing B”, and is approximately 1 μm. Further, the arithmetic average roughness Ra of the surface 10g1a (see FIG. 3C) of the sealant layer 10g1 (see FIG. 3C) according to the method for manufacturing the piston for the internal combustion engine of the first embodiment corresponds to a numerical value for “polishing B”, and is approximately 1 μm. That is, the arithmetic average roughness Ra of the wall surface 10a1a (see FIG. 1) of the cavity 10a1 (see FIG. 1) after completion of the piston 10 for an internal combustion engine that is manufactured by the method for manufacturing the piston for the internal combustion engine of the first embodiment corresponds to a numerical value for “polishing B”, and is approximately 1 μm.

Further, in the example illustrated in FIG. 7A, the arithmetic average roughness Ra of the surface 10c4′(see FIG. 5B) of the anodic oxide coating 10c (see FIG. 5B) according to the method for manufacturing the piston for the internal combustion engine of the comparative example corresponds to a numerical value for “polishing A”, and is approximately 2 μm. Furthermore, the arithmetic average roughness Ra of the surface 10g1a′ (see FIG. 5C) of the sealant layer 10g1′ (see FIG. 5C) according to the method for manufacturing the piston for the internal combustion engine of the comparative example corresponds to a numerical value for “polishing A”, and is approximately 2 μm. That is, the arithmetic average roughness Ra of the wall surface 10a1a (see FIG. 1) of the cavity 10a1 (see FIG. 1) after completion of the piston 10 for an internal combustion engine that is manufactured by the method for manufacturing the piston for the internal combustion engine of the comparative example corresponds to a numerical value for “polishing A”, and is approximately 2 μm.

In the example illustrated in FIG. 7B, the maximum height roughness Rp of the surface 10b1 (see FIG. 2A) of the base material 10b (see FIG. 2A) according to the method for manufacturing the piston for the internal combustion engine of the first embodiment corresponds to a numerical value for “base”, and is approximately 7 μm. Further, the maximum height roughness Rp of the surface 10c1 (see FIG. 2B) of the anodic oxide coating 10c (see FIG. 2B) after execution of the deposition process in the method for manufacturing the piston for the internal combustion engine of the first embodiment corresponds to a numerical value for “unpolished”, and is approximately 38 μm. In addition, the maximum height roughness Rp of the smoothed surface 10c4 (see FIG. 3B) of the anodic oxide coating 10c (see FIG. 3B) according to the method for manufacturing the piston for the internal combustion engine of the first embodiment corresponds to a numerical value for “polishing B”, and is approximately 7 to 8 μm. Furthermore, the maximum height roughness Rp of the surface 10g1a (see FIG. 3C) of the sealant layer 10g1 (see FIG. 3C) according to the method for manufacturing the piston for the internal combustion engine of the first embodiment corresponds to a numerical value for “polishing B”, and is approximately 7 to 8 μm. That is, the maximum height roughness Rp of the wall surface 10a1a (see FIG. 1) of the cavity 10a1 (see FIG. 1) after completion of the piston 10 for an internal combustion engine that is manufactured by the method for manufacturing the piston for the internal combustion engine of the first embodiment corresponds to a numerical value for “polishing B”, and is approximately 7 to 8 μm.

Further, in the example illustrated in FIG. 7B, the maximum height roughness Rp of the surface 10c4′ (see FIG. 5B) of the anodic oxide coating 10c (see FIG. 5B) according to the method for manufacturing the piston for the internal combustion engine of the comparative example corresponds to a numerical value for “polishing A”, and is approximately 19 to 20 μm. Furthermore, the maximum height roughness Rp of the surface 10g1a′ (see FIG. 5C) of the sealant layer 10g1′ (see FIG. 5C) according to the method for manufacturing the piston for the internal combustion engine of the comparative example corresponds to a numerical value for “polishing A”, and is approximately 19 to 20 μm. That is, the maximum height roughness Rp of the wall surface 10a1a (see FIG. 1) of the cavity 10a1 (see FIG. 1) after completion of the piston 10 for an internal combustion engine that is manufactured by the method for manufacturing the piston for the internal combustion engine of the comparative example corresponds to a numerical value for “polishing A”, and is approximately 19 to 20 μm.

In the example illustrated in FIG. 7C, the ten-point average roughness Rzjis of the surface 10b1 (see FIG. 2A) of the base material 10b (see FIG. 2A) according to the method for manufacturing the piston for the internal combustion engine of the first embodiment corresponds to a numerical value for “base”, and is approximately 13 μm. Further, the ten-point average roughness Rzjis of the surface 10c1 (see FIG. 2B) of the anodic oxide coating 10c (see FIG. 2B) after execution of the deposition process in the method for manufacturing the piston for the internal combustion engine of the first embodiment corresponds to a numerical value for “unpolished”, and is approximately 58 μm. In addition, the ten-point average roughness Rzjis of the smoothed surface 10c4 (see FIG. 3B) of the anodic oxide coating 10c (see FIG. 3B) according to the method for manufacturing the piston for the internal combustion engine of the first embodiment corresponds to a numerical value for “polishing B”, and is approximately 16 to 17 μm. Furthermore, the ten-point average roughness Rzjis of the surface 10g1a (see FIG. 3C) of the sealant layer 10g1 (see FIG. 3C) according to the method for manufacturing the piston for the internal combustion engine of the first embodiment corresponds to a numerical value for “polishing B”, and is approximately 16 to 17 μm. That is, the ten-point average roughness Rzjis of the wall surface 10a1a (see FIG. 1) of the cavity 10a1 (see FIG. 1) after completion of the piston 10 for an internal combustion engine that is manufactured by the method for manufacturing the piston for the internal combustion engine of the first embodiment corresponds to a numerical value for “polishing B”, and is approximately 16 to 17 μm.

Further, in the example illustrated in FIG. 7C, the ten-point average roughness Rzjis of the surface 10c4′(see FIG. 5B) of the anodic oxide coating 10c (see FIG. 5B) according to the method for manufacturing the piston for the internal combustion engine of the comparative example corresponds to a numerical value for “polishing A”, and is approximately 27 μm. Furthermore, the ten-point average roughness Rzjis of the surface 10g1a′ (see FIG. 5C) of the sealant layer 10g1′ (see FIG. 5C) according to the method for manufacturing the piston for the internal combustion engine of the comparative example corresponds to a numerical value for “polishing A”, and is approximately 27 μm. That is, the ten-point average roughness Rzjis of the wall surface 10a1a (see FIG. 1) of the cavity 10a1 (see FIG. 1) after completion of the piston 10 for an internal combustion engine that is manufactured by the method for manufacturing the piston for the internal combustion engine of the comparative example corresponds to a numerical value for “polishing A”, and is approximately 27 μm.

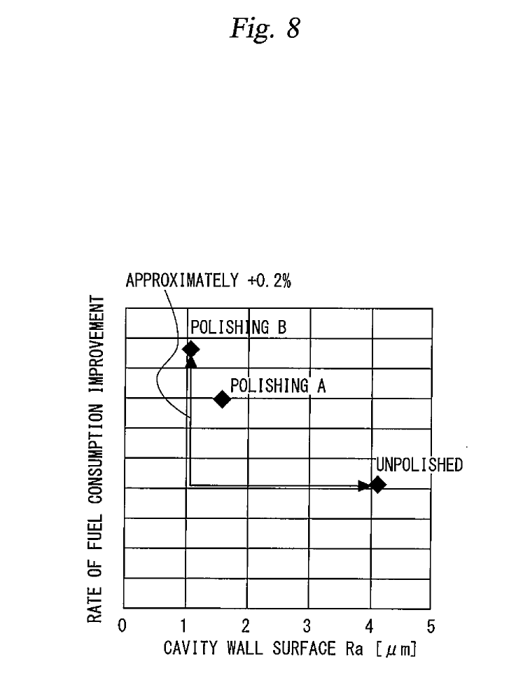

FIG. 8 is a view for describing a rate of fuel consumption improvement that is achieved by the piston 10 for an internal combustion engine that is manufactured by the method for manufacturing the piston for the internal combustion engine of the first embodiment. In FIG. 8, the vertical axis represents the rate of fuel consumption improvement, and the horizontal axis represents the arithmetic average roughness Ra of the wall surface 10a1a (see FIG. 1) of the cavity 10a1 (see FIG. 1) and which shows the arithmetic average roughness Ra for “unpolished”, “polishing A” and “polishing B” in FIG. 7A.

As illustrated in FIG. 8, according to the method for manufacturing the piston for the internal combustion engine of the first embodiment, in comparison to the case of “unpolished” in FIG. 8 (that is, a case where a sealant layer is formed without executing the polishing process illustrated in FIG. 5B), fuel consumption can be improved by approximately 0.2%.

More specifically, in the method for manufacturing the piston for the internal combustion engine of the first embodiment, for example, polysilazane is used as the sealants 10d and 10f (see FIG. 4B and FIG. 4E), and as a result the sealant layers 10e1, 10e2 and 10g1 (see FIG. 3A and FIG. 3C) are constituted by silicon oxide. Specifically, for example, a solution including AQUAMICA® (perhydrosilazane with an SiO₂ component) manufactured by AZ Electronic Materials SA and an ether-based organic solvent can be used as the sealants 10d and 10f. The sealants 10d and 10f react with moisture in air and are denatured into SiO₂ (that is, form the sealant layers 10e1, 10e2 and 10g1), and an entrance portion of the nanopores 10c2a, 10c2b, 10c2c, 10c2d, 10c2e and 10c2f (see FIG. 2B) can be blocked up by the sealant layer 10g1.

Any sealant can be used as the sealants 10d and 10f as long as the sealant can satisfy the reinforcing process illustrated in FIG. 3A and the sealing process illustrated in FIG. 3C.

The method for manufacturing the piston for the internal combustion engine of the first embodiment can be applied to any piston for the internal combustion engine such as a piston for a gasoline engine and a piston for a diesel engine. In a case where the method for manufacturing the piston for the internal combustion engine of the first embodiment is applied to, for example, a piston for a diesel engine, the wall surface 10a1a (see FIG. 1) of the cavity 10a1 (see FIG. 1) in the top surface 10a (see FIG. 1) of the piston 10 for an internal combustion engine (see FIG. 1) that is manufactured by the method for manufacturing the piston for the internal combustion engine of the first embodiment corresponds to a fuel spray collision portion.

Furthermore, in the method for manufacturing the piston for the internal combustion engine of the first embodiment, in the reinforcing process illustrated in FIG. 3A and the sealing process illustrated in FIG. 3C, the sealants 10d and 10f in solution form (see FIG. 4B and FIG. 4E) are applied on the anodic oxide coating 10c by an arbitrary technique such as spraying, dipping or brush coating.

In the piston 10 for an internal combustion engine (see FIG. 1) manufactured by the method for manufacturing the piston for the internal combustion engine of the first embodiment, the anodic oxide coating 10c (see FIG. 3C) is formed that has a large number of nanopores 10c2a, 10c2b, 10c2c, 10c2d, 10c2e and 10c2f (see FIG. 2B) and a large number of micropores 10c3a, 10c3b and 10c3c (see FIG. 2B) and in which an air layer remains inside the number of nanopores 10c2a, 10c2b, 10c2c, 10c2d, 10c2e and 10c2f and the number of micropores 10c3a, 10c3b and 10c3c. Therefore, the inside of the combustion chamber and the base material 10b (see FIG. 2A) of the piston 10 for an internal combustion engine can be thermally insulated from each other, and the amount of heat transfer from gas inside the combustion chamber to the base material 101) of the piston 10 for an internal combustion engine can be reduced.

In the example illustrated in FIG. 7 in which the method for manufacturing the piston for the internal combustion engine of the first embodiment is applied, the arithmetic average roughness Ra (numerical value for “polishing B” in FIG. 7A) of the wall surface 10a1a (see FIG. 1) of the cavity 10a1 (see FIG. 1) after completion of the piston 10 for an internal combustion engine is approximately 1 μm, the maximum height roughness Rp thereof (numerical value for “polishing B” in FIG. 7B) is approximately 7 to 8 μm, and the ten-point average roughness Rzjis thereof (numerical value for “polishing B” in FIG. 7C) is approximately 16 to 17 μm. However, in other examples in which the method for manufacturing the piston for the internal combustion engine of the first embodiment is applied, instead of the aforementioned values, it is also possible to make the arithmetic average roughness Ra of the wall surface 10a1a of the cavity 10a1 after completion of the piston 10 for an internal combustion engine approximately 1.5 μm or less, or to make the maximum height roughness Rp thereof or a maximum trough depth (numerical value of the depth of the largest trough in the roughness curve within the measuring range (reference length 1)) Rv approximately 10 μm or less, or to make the ten-point average roughness Rzjis approximately 20 μm or less.

Hereunder, a second embodiment of the method for manufacturing the piston for the internal combustion engine according to the present application will be described.

In the method for manufacturing the piston for the internal combustion engine of the second embodiment, with the exception of a process that is described later, similar processes as the processes in the above described method for manufacturing the piston for the internal combustion engine of the first embodiment are executed. Accordingly, with the exception of a point that is described later, similar advantageous effects as those obtained by the above described method for manufacturing the piston for the internal combustion engine of the first embodiment can also be obtained by the method for manufacturing the piston for the internal combustion engine of the second embodiment.

As described above, in the method for manufacturing the piston for the internal combustion engine of the first embodiment, the sealants 10d and 10f that are identical (see FIG. 4B and FIG. 4E) are used in the reinforcing process illustrated in FIG. 3A and the sealing process illustrated in FIG. 3C (that is, the sealant 10d and the sealant 10f are the same kind of sealant (the same material and the same viscosity)).

In contrast, in the method for manufacturing the piston for the internal combustion engine of the second embodiment, although the sealant 10d and 10f (see FIG. 4B and FIG. 4E) are used in the reinforcing process illustrated in FIG. 3A and the sealing process illustrated in FIG. 3C, the viscosity of the sealant 10d that is used in the reinforcing process illustrated in FIG. 3A is made less than the viscosity of the sealant 10f that is used in the sealing process illustrated in FIG. 3C.

Therefore, in the method for manufacturing the piston for the internal combustion engine of the second embodiment, in comparison to a case in which the sealant 10d having a large viscosity is used in the reinforcing process illustrated in FIG. 3A, the sealant 10d can be reliably caused to impregnate as far as a deep portion (portion that is a large distance from the surface 10c1 (see FIG. 2B) of the anodic oxide coating 10c) inside the nanopores 10c2a, 10c2b, 10c2c, 10c2d, 10c2e and 10c2f (see FIG. 2B) and the micropores 10c3a, 10c3b and 10c3c (see FIG. 2B) of the anodic oxide coating 10c during execution of the reinforcing process illustrated in FIG. 3A, and thereby the rigidity of the anodic oxide coating 10c after execution of the reinforcing process illustrated in FIG. 3A can be improved.

In addition, in the method for manufacturing the piston for the internal combustion engine of the second embodiment, the viscosity of the sealant 10f (see FIG. 4F) that is used in the sealing process illustrated in FIG. 3C is made larger than the viscosity of the sealant 10d (see FIG. 4B) used in the reinforcing process illustrated in FIG. 3A.

Therefore, in the method for manufacturing the piston for the internal combustion engine of the second embodiment, in comparison to a case in which the sealant 10f having a small viscosity is used in the sealing process illustrated in FIG. 3C, it becomes difficult for the sealant 10f to impregnate as far as a deep portion (portion that is a large distance from the surface 10c4 (see FIG. 3B) of the anodic oxide coating 10c) inside the nanopores 10c2a, 10c2b, 10c2c, 10c2d, 10c2e and 10c2f (see FIG. 2B) and the micropores 10c3a, 10c3b and 10c3c (see FIG. 2B) of the anodic oxide coating 10c during execution of the sealing process illustrated in FIG. 3C. As a result, a space (air layer) remaining inside the nanopores 10c2a, 10c2b, 10c2c, 10c2d, 10c2e and 10c2f and the micropores 10c3a, 10c3b and 10c3c of the anodic oxide coating 10c after completion of the piston 10 for an internal combustion engine can be increased, and thereby a heat insulating characteristic of the piston 10 for an internal combustion engine can be improved.

More specifically, although in the method for manufacturing the piston for the internal combustion engine of the first embodiment the sealant 10f (see FIG. 4F) used in the sealing process enters into the nanopores 10c2a, 10c2b, 10c2c, 10c2d, 10c2e and 10c2f (see FIG. 2B) and the micropores 10c3a, 10c3b and 10c3c (see FIG. 2B), in an example to which the method for manufacturing the piston for the internal combustion engine of the second embodiment is applied, in the sealing process it is possible to use the sealant 10f whose viscosity is sufficiently large to ensure the sealant 10f used in the sealing process does not enter inside the nanopores 10c2a, 10c2b, 10c2c, 10c2d, 10c2e and 10c2f and the micropores 10c3a, 10c3b and 10c3c.

That is, in an example in which the method for manufacturing the piston for the internal combustion engine of the second embodiment is applied, the sealant 10f (see FIG. 4E) for the sealing process does not enter inside the nanopores 10c2a, 10c2b, 10c2c, 10c2d, 10c2e and 10c2f and the micropores 10c3a, 10c3b and 10c3c, the sealant layer 10g2 (see FIG. 4F) is not formed on the inner wall surface of the nanopores 10c2a, 10c2b, 10c2c, 10c2d, 10c2e and 10c2f and the micropores 10c3a, 10c3b and 10c3c.

In other words, in this example, when executing the process illustrated in FIG. 4E, the sealant 10f is not present inside the nanopore 10c2a, and when executing the process illustrated in FIG. 4F, the sealant layer 10g2 is not formed inside the nanopore 10c2a.

To reduce the viscosity of the sealant 10d (see FIG. 4B) in the method for manufacturing the piston for the internal combustion engine of the second embodiment, for example, an organic solvent with a small viscosity can be used as the organic solvent constituting a part of the sealant 10d. That is, by making the kinds of organic solvent used for the sealant 10d and the sealant 10f (see FIG. 4F) different to each other, the viscosity of the sealant 10d can be made less than the viscosity of the sealant 10f.

Alternatively, even in a case where the same kind of organic solvent is used for the sealant 10d and the sealant 10f, by making the proportion of the organic solvent included in the sealant 10f greater than the proportion of the organic solvent included in the sealant 10d, the viscosity of the sealant 10d can be made less than the viscosity of the sealant 10f. That is, by making the concentration of the organic solvent in the sealant 10d higher than the concentration of the organic solvent in the sealant 10f, the viscosity of the sealant 10d can be made less than the viscosity of the sealant 10f.

Hereunder, a third embodiment of the method for manufacturing the piston for the internal combustion engine according to the present application will be described.

In the method for manufacturing the piston for the internal combustion engine of the third embodiment, with the exception of a process that is described later, similar processes as the processes in the above described method for manufacturing the piston for the internal combustion engine of the first embodiment are executed. Accordingly, with the exception of a point that is described later, similar advantageous effects as those obtained by the above described method for manufacturing the piston for the internal combustion engine of the first embodiment can also be obtained by the method for manufacturing the piston for the internal combustion engine of the third embodiment.

As described above, in the method for manufacturing the piston for the internal combustion engine of the first embodiment, in the reinforcing process illustrated in FIG. 3A the sealant layers 10e1 and 10e2 are formed on the anodic oxide coating 10c deposited by the deposition process illustrated in FIG. 2B, and thereby the anodic oxide coating 10c deposited by the deposition process illustrated in FIG. 2B is reinforced. As a result, in the polishing process illustrated in FIG. 3B, the smoothed surface 10c4 can be formed on the anodic oxide coating 10c.

In the method for manufacturing the piston for the internal combustion engine of the third embodiment, the sealant 10d (see FIG. 4B) is not used for reinforcing the anodic oxide coating 10c deposited by the deposition process illustrated in FIG. 2B. Instead, to reinforce the anodic oxide coating 10c deposited by the deposition process illustrated in FIG. 2B, a known reinforcing process such as a process that uses pressurized steam or a boiling process in boiling water is executed.

By the method for manufacturing the piston for the internal combustion engine of the third embodiment also, similarly to the method for manufacturing the piston for the internal combustion engine of the first embodiment, the surface roughness (smoothness) of the smoothed surface 10c4 of the anodic oxide coating 10c after execution of the polishing process illustrated in FIG. 3B can be improved, and the heat capacity of the sealant layer 10g1 (see FIG. 3C) formed on the smoothed surface 10c4 can be reduced.

According to a fourth embodiment, the above described first to third embodiments and the respective examples can also be appropriately combined.

What is claimed is:

1. A method for manufacturing a piston for an internal combustion engine, a base material of the piston being an aluminum alloy, a cavity being formed in a top surface of the piston, comprising:
a depositing step of depositing a porous anodic oxide coating on a portion of a surface of the base material, the portion corresponding to a wall surface of the cavity;
a reinforcing step of reinforcing the anodic oxide coating that is deposited by the depositing step;
a polishing step of forming a smoothed surface of the anodic oxide coating by polishing the anodic oxide coating that is reinforced by the reinforcing step; and
a sealing step of applying a sealant on the smoothed surface of the anodic oxide coating that is formed by the polishing step.

2. The method for manufacturing the piston for the internal combustion engine according to claim 1, wherein, in the reinforcing step, the anodic oxide coating that is deposited by the depositing step is reinforced by applying the sealant until the sealant accumulates on the surface of the anodic oxide coating that is deposited by the depositing step.

3. The method for manufacturing the piston for the internal combustion engine according to claim 2, wherein, in the polishing step, the sealant that is accumulated on the surface of the anodic oxide coating by the reinforcing step is removed by polishing.

4. The method for manufacturing the piston for the internal combustion engine according to claim 1, wherein in the reinforcing step, the anodic oxide coating that is deposited by the depositing step is reinforced by applying the sealant, and
wherein the same sealant is used in the reinforcing step and the sealing step.

5. The method for manufacturing the piston for the internal combustion engine according to claim 1, wherein in the reinforcing step, the anodic oxide coating that is deposited by the depositing step is reinforced by applying a sealant, and
wherein a viscosity of the sealant that is used in the reinforcing step is less than a viscosity of the sealant that is used in the sealing step.
